(19) United States
(12) Patent Application Publication
(10) Pub. No.: US 2025/0206286 A1
(43) Pub. Date: Jun. 26, 2025

(54) Intelligent Stop Control Method and Intelligent Stop Control System

(71) Applicant: Wistron Corporation, New Taipei City (TW)

(72) Inventor: Shih-Jui Liu, New Taipei City (TW)

(73) Assignee: Wistron Corporation, New Taipei City (TW)

(21) Appl. No.: 18/603,172

(22) Filed: Mar. 12, 2024

(30) Foreign Application Priority Data
Dec. 21, 2023 (TW) 112149950

(51) Int. Cl. B60W 10/24; B60W 30/18; H04W 4/44

(52) U.S. Cl. CPC B60W 10/24; B60W 30/181; B60W 30/18154; H04W 4/44; B60W 2552/53; B60W 2554/406; B60W 2554/80; B60W 2555/60; B60W 2556/45

(57) ABSTRACT

An intelligent stop control method, for a vehicle, includes obtaining a traffic status information related to the vehicle through a vehicle-to-everything system when the vehicle is driving; and in response to activation of a brake system of the vehicle, controlling operation of a power system of the vehicle based on the traffic status information.

### BACKGROUND OF THE INVENTION

### 1. Field of the Invention

The present invention relates to an intelligent stop control method and intelligent stop control system, and more particularly, to an intelligent stop control method and intelligent stop control system capable of appropriately adjusting an operation mode of a power system of a vehicle according to actual needs.

### 2. Description of the Prior Art

To improve the energy efficiency of vehicles, in addition to improving motor efficiency, the prior art has provided different energy-saving improvement solutions for vehicle deceleration.

For example, for a gasoline vehicle, the idle stop system is a technology that can automatically shut down the power system when the vehicle stops and restart the power system when the accelerator is stepped on, thus effectively saving fuel and reducing emissions. However, in the prior art, the idle stop system uses a fixed detection and activation mechanism. For example, whenever the vehicle stops for more than 3 seconds during driving, the idle stop system shuts down the power system and restarts the power system when the accelerator is stepped on. In this case, if the vehicle only needs to shortly stop (for example, stop-and-go traffic, waiting for a red light to turn green, or waiting the front cars in line to drive at a traffic light), the frequent intervention of the idle stop system instead causes annoying delays and jerks, and also causes unnecessary wear and tear on the power system, reducing the performance of air conditioning and generators, etc.

On the other hand, for electric vehicles or hybrid vehicles (which have both an internal combustion engine and a drive motor), the kinetic energy recovery system is a technology that captures and stores kinetic energy by reversing the operation of the motor. Generally speaking, the kinetic energy of a traditional vehicle is lost in the form of heat when the vehicle brakes, but in an electric vehicle or hybrid vehicle, it can be converted into electrical energy through the motor and stored in the battery for subsequent use. The working principle of the kinetic energy recovery system is that when the driver steps on the brake, the electric motor stops transmitting kinetic energy, operates in reverse as a generator, and converts the kinetic energy of the vehicle into electrical energy. The generated electrical energy can be stored in the vehicle's battery, thereby extending its cruising range and improving overall energy efficiency. However, in the prior art, drivers can only manually turn on or off the kinetic energy recovery system, which is not easy to operate and has safety concerns. Even after turned on, the kinetic energy recovery system recovers kinetic energy with the same recovery strength, which may cause discomfort to the driver or passengers. For example, when the traffic condition is poor and the vehicle is in low-speed crawling but not serious enough to stop completely or stop and go, the strong recovery strength can easily cause a noticeable jerk, causing the driver to need to control the throttle and brakes more precisely, and thus adding to fatigue. Conversely, when traffic conditions are good or driving downhill, the low recovery strength cannot effectively recover vehicle kinetic energy, and will increase the wear and tear of the brake system, and is not conducive to extending the cruising range.

Therefore, how to improve the operation mode of vehicle deceleration to conform to the needs of drivers has become one of the goals that the industry strives for.

### SUMMARY OF THE INVENTION

Therefore, the present invention is to an intelligent stop control method and intelligent stop control system to improve the drawbacks of the prior art.

An embodiment of the present invention discloses an intelligent stop control method, for a vehicle. The intelligent stop control method comprises obtaining a traffic status information related to the vehicle through a vehicle-to-everything system when the vehicle is driving; and in response to activation of a brake system of the vehicle, controlling operation of a power system of the vehicle based on the traffic status information.

Another embodiment of the present invention discloses an intelligent stop control system for a vehicle. The intelligent stop control system comprises a processing unit; a transceiver module, coupled to the processing unit, configured to connect a vehicle-to-everything system; a storage unit, coupled to the processing unit, storing a program code, wherein the program code is used to instruct the processing unit to execute an intelligent stop control method, wherein the intelligent stop control method comprises the following steps: obtaining a traffic status information related to the vehicle through the vehicle-to-everything system when the vehicle is driving; and in response to activation of a brake system of the vehicle, controlling operation of a power system of the vehicle based on the traffic status information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a drive system according to an embodiment of the present invention.

FIG. 2 is a schematic diagram of an intelligent stop control system shown in FIG. 1.

FIG. 3 is a schematic diagram of a process according to an embodiment of the present invention.

FIG. 4 is a schematic diagram of a process according to an embodiment of the present invention.

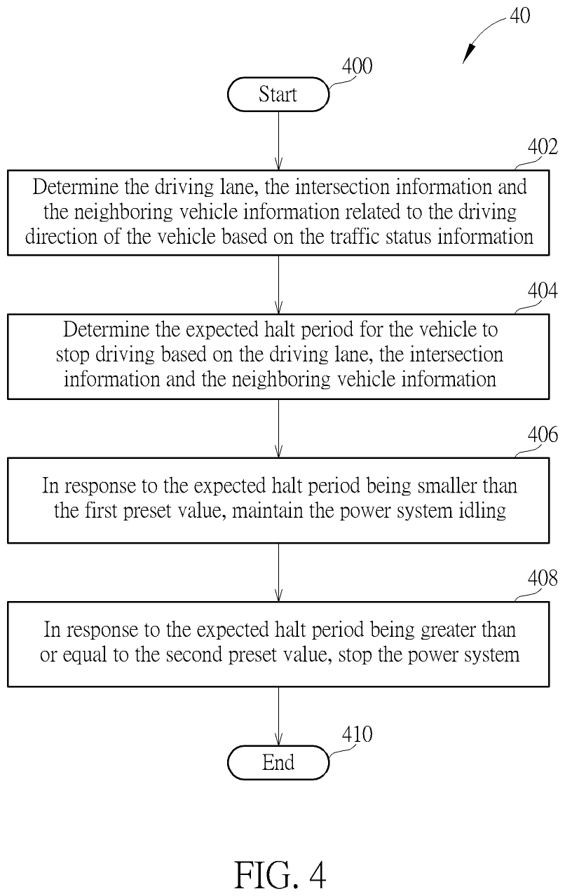

FIG. 5A is a schematic diagram of a first algorithm according to an embodiment of the present invention.

FIG. 5B is a schematic diagram of a second algorithm according to an embodiment of the present invention.

FIG. 5C is a schematic diagram of a third algorithm according to an embodiment of the present invention.

### DETAILED DESCRIPTION

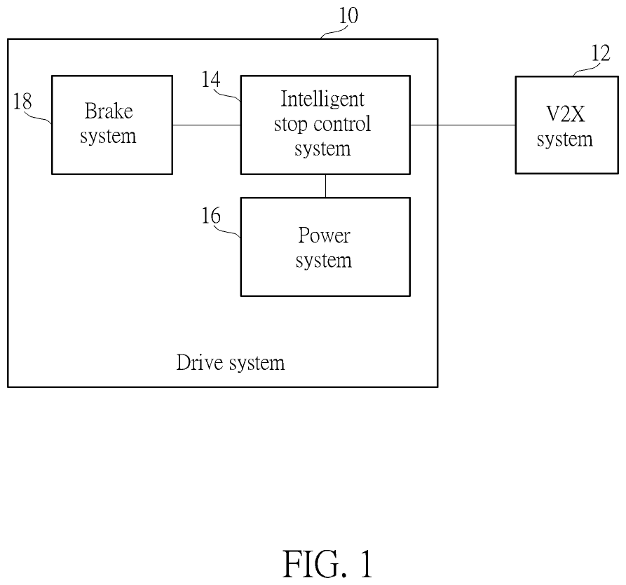

Please refer to FIG. 1, which is a schematic diagram of a drive system 10 according to an embodiment of the present invention. The drive system 10 is used for a vehicle, such as a car, motorcycle, large vehicle, etc., which are motor vehicles traveling on the road. The drive system 10 includes an intelligent stop control system 14, a power system 16, and a brake system 18. The intelligent stop control system 14 may communicate with a Vehicle-to-Everything (V2X) system 12 to adaptively control the operation mode of the power system 16 (such as idling or kinetic energy recovery operation) based on traffic conditions. It should be noted that the drive system 10 is only used to represent the basic structure driving the vehicle, but is not limited thereto. Those skilled in the art should appropriately make modification according to the system requirements. For example, the power system 16 refers to the overall system that generates propulsion power. For the power system of an internal combustion engine vehicle, it may include an engine ignition system, a fuel supply device, etc., and further connect to a generator, a transmission system, etc. For the power system of an electric vehicle, it may include a motor, a motor controller, and further connect to a power battery pack, etc., which are well known to those skilled in the art and do not affect the operation of the embodiments of the present invention, so they will not be described in detail. The brake system 18 roughly includes a brake master pump, a sub-pump (caliper), a brake oil pipe, and a disc brake or drum brake assembly, which are well known to those skilled in the art and do not affect the operation of the embodiments of the present invention, so they will not be described in detail.

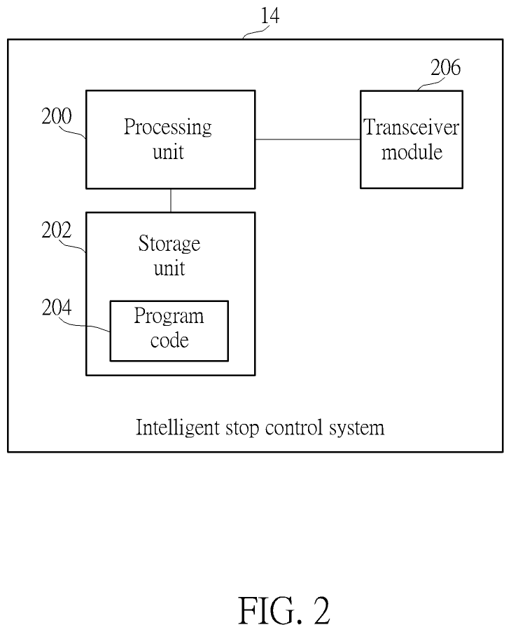

Please continue to refer to FIG. 2, which is a schematic diagram of the intelligent stop control system 14 shown in FIG. 1. The intelligent stop control system 14 includes a processing unit 200, a storage unit 202, and a transceiver module 206. The processing unit 200 may be a general-purpose processor, a microprocessor, an Application Specific Integrated Circuit (ASIC), a Field Programmable Gate Array (FPGA), a Neural Processing Unit (NPU), a Tensor Processing Unit (TPU), etc., or a combination thereof. The storage unit 202 is coupled to the processing unit 200 and may be any data storage device for storing a program code 204 and reading and executing the program code 204 through the processing unit 200. For example, the storage unit 202 may be a Read-Only Memory (ROM), Flash Memory, Random Access Memory (RAM), non-volatile storage unit, etc., but is not limited thereto. In addition, the transceiver module 206 is coupled to the processing unit 200 and is used to connect to the V2X system 12 through wired or wireless communication methods to obtain traffic status information, and then provide the traffic status information for the processing unit 200 to control the operation mode of the power system 16. The V2X system 12 is a system that uses wireless communication technology to realize information exchange and coordination between vehicles, roads, traffic facilities, and personnel. The V2X system 12 includes an On-Board Unit (OBU) installed on the vehicle, a Road Side Unit (RSU) installed on the road or a traffic facility, and a central platform responsible for collecting or processing data. Therefore, those skilled in the art should understand that although FIG. 1 shows the V2X system 12 in a single block, it represents a collection of at least one OBU, at least one RSU, and at least one central platform, and the at least one OBU includes not only the OBU of the vehicle itself, but also the OBU(s) of neighboring car(s), and the OBU(s), RSU(s), and central platform(s) may exchange information and coordinate through wireless communication methods. The embodiments of the present invention use the information of the V2X system 12 to determine the traffic status and then control the operation mode of the power system 16.

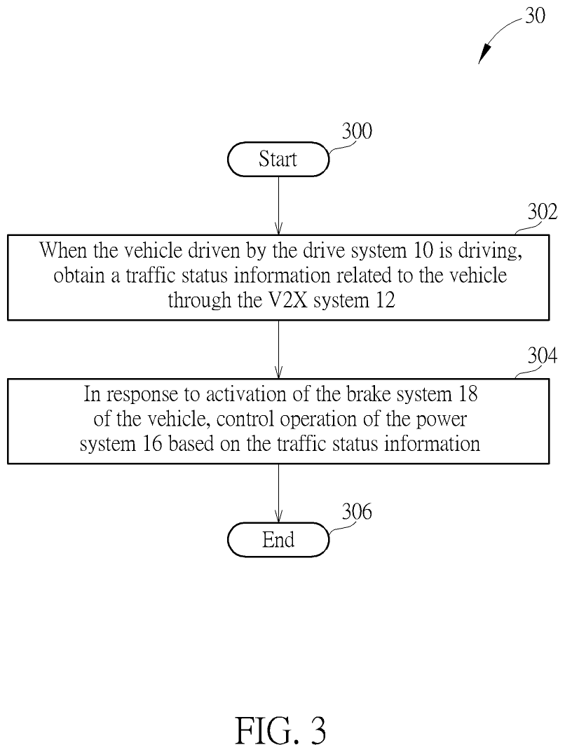

In detail, please refer to FIG. 3, which is a schematic diagram of a process 30 according to an embodiment of the present invention. The process 30 is used for the drive system 10 to implement an intelligent stop control method, which can be compiled into the program code 204 and stored in the storage unit 202. The process 30 includes the following steps:
Step 300: Start.
Step 302: When the vehicle driven by the drive system 10 is driving, obtain a traffic status information related to the vehicle through the V2X system 12.
Step 304: In response to activation of the brake system 18 of the vehicle, control operation of the power system 16 based on the traffic status information.
Step 306: End.

According to the process 30, when the vehicle driven by the drive system 10 is driving, the transceiver module 206 of the intelligent stop control system 14 may communicate with the V2X system 12 to obtain the traffic status information related to the vehicle (Step 302). In response to the activation of the brake system 18 of the vehicle, the processing unit 200 of the intelligent stop control system 14 may control (or adjust) the operation of the power system 16 based on the traffic status information obtained by the transceiver module 206 (Step 304). In other words, during the driving of the vehicle, if the driver steps on the brake, the embodiment of the present invention determines the real-time traffic status information based on the information of the V2X system 12, and dynamically determines the operation of the power system 16 accordingly, such as (for a gasoline vehicle) maintaining idling operation or stopping operation, or (for an electric vehicle or hybrid vehicle) controlling the ON/OFF or the strength of kinetic energy recovery. In such a situation, for the gasoline vehicle, if the car only needs to stop briefly (for example: stop-and-go traffic, waiting for the red light to turn green, or waiting the front car in line to drive at the traffic light), the embodiment of the present invention may determine that the power system 16 does not need to be turned off based on the information of the V2X system 12, thus avoiding the delay, jerk or wear caused by frequent shutdown and startup of the power system 16, to meet the road conditions and driver's needs. On the other hand, if the traffic status information shows that the current stop will take a longer time (such as the remaining time of the red light is longer, there is a traffic jam ahead, etc.), the embodiment of the present invention may turn off the operation of the power system 16 to reduce energy consumption. Moreover, for the electric vehicle or hybrid vehicle, when the traffic condition is poor and the vehicle is in low-speed crawling but not serious enough to stop completely or stop and go, the embodiment of the present invention may use the motor controller to turn off the kinetic energy recovery of the power system 16 or reduce the recovery strength based on the information of the V2X system 12, to reduce driver fatigue. On the other hand, when the traffic conditions are good or the vehicle drives downhill, the embodiment of the present invention may turn on kinetic energy recovery or increase recovery strength to reduce the wear of the brake system and extend the cruising range.

It should be noted that the process 30 is an embodiment of the present invention, and those skilled in the art may make different modifications according to different requirements. For example, in Step 302, the intelligent stop control system 14 obtains the traffic status information related to the vehicle through the V2X system 12, which specifically includes vehicle-to-vehicle (V2V) messages and vehicle-to-infrastructure (V2I) messages. For these messages, different organizations may have different names or definitions. For example, for V2V messages, the Society of Automotive Engineers (SAE) names them Basic Safety Messages (BSM), while the European Telecommunications Standards Institute (ETIS) names them Cooperative Awareness Messages (CAM); for V2I messages, SAE names them Signal Phase and Timing (SPaT) and MAP messages, while ETIS names them Decentralized Environmental Notification Messages (DENM). Even though different organizations have different names or definitions for V2V messages and V2I messages, those skilled in the art should know that the V2V messages and V2I messages may be used to determine the driving lane, the intersection information and the neighboring vehicle information related to a driving direction of the vehicle. In such a situation, in Step 304, in response to the brake system 18 being activated, the intelligent stop control system 14 may determine the driving lane of the vehicle, the intersection information ahead of the driving direction, and the driving information of the neighboring vehicles (such as the speeds, driving lanes, directions, etc.) based on the traffic status information of the V2X system 12. Accordingly, for the idling operation of the gasoline vehicle, the intelligent stop control system 14 may determine an expected halt period for the driver to stop driving by stepping on the brake, and maintain the power system 16 idling in response to the expected halt period being smaller than a first preset value, and stop the power system 16 in response to the expected halt period being greater than or equal to a second preset value. That is, if the intelligent stop control system 14 determines that the vehicle is only temporarily stopped based on the traffic status information of the V2X system 12, the power system 16 is maintained idling to avoid frequent shutdowns and startups; on the contrary, if the vehicle may stop for a longer time, the power system 16 is turned off to reduce energy consumption. The first preset value and the second preset value may be the same, indicating that the intelligent stop control system 14 compares the expected halt period with a single specific value to decide whether to maintain the power system 16 idling or stop the power system 16; or, the second preset value may be greater than the first preset value, indicating that there is a buffer zone between the first preset value and the second preset value; that is, in response to the expected halt period being between the first preset value and the second preset value, the intelligent stop control system 14 does not change the current operation mode of the power system 16.

The above implementation of Step 304 may be summarized as a process 40, which can be compiled into the program code 204 and stored in the storage unit 202. The process 40 aims at the idling operation of the gasoline vehicle, which includes the following steps:
Step 400: Start.
Step 402: Determine the driving lane, the intersection information and the neighboring vehicle information related to the driving direction of the vehicle based on the traffic status information.
Step 404: Determine the expected halt period for the vehicle to stop driving based on the driving lane, the intersection information and the neighboring vehicle information.
Step 406: In response to the expected halt period being smaller than the first preset value, maintain the power system idling.
Step 408: In response to the expected halt period being greater than or equal to the second preset value, stop the power system.
Step 410: End.

According to the process 40, when the driver steps on the brake and stops the vehicle, the intelligent stop control system 14 determines the expected halt period of the vehicle based on the traffic status information of the V2X system 12, and accordingly decides to turn off the power system 16 or maintain the power system 16 idling. Specifically, in Step 402, the intelligent stop control system 14 determines the driving lane, the intersection information and the neighboring vehicle information of the vehicle based on the traffic status information, for subsequent determination of the traffic conditions and the possible halt period caused by them. Since different organizations have different definitions for V2V messages and V2I messages, the following examples are based on BSM, SPaT and MAP messages of SAE. In addition, as well known in the art, an intersection is any location where two or more roads intersect, which can be a branch intersection, a ramp intersection, a T-intersection, etc., and is not limited thereto. For the sake of simplicity, the following examples use a cross intersection as an example. Please refer to Tables 1 to 3, which are summaries of the contents of BSM, SPaT and MAP messages, respectively.

TABLE 1

| Contents of BSM | Meanings |
|---|---|
| Latitude, Longitude, Elevation | GPS coordinates |
| Speed | Driving speed |
| Heading | Driving direction |

TABLE 2

| Contents of SPaT | Meanings |
|---|---|
| intersections.list.array | Set of signal phase and timing |
| | of intersection |
| intersections.list.array[x].id.id | Identification of intersection x |
| intersection.states.list.array[ ] | Intersection state set |
| intersection.states.list.array[x]. | Identification of intersection |
| signalGroup | state x |
| intersection.states.list.array[x]. | Set of light, speed and time |
| state_time_speed.list.array[ ] | states of intersection state x |
| intersection.states.list.array[x]−>state_{—} | State (red, green, yellow) of |
| time_speed.list.array[y].eventState | light y of intersection state x |
| intersection.states.list.array[x]−>state_{—} | End time point of light y of |
| time_speed.list.array[y].timing. | intersection state x |
| minEndTime | |

TABLE 3

| Contents of MAP | Meanings |
|---|---|
| Intersections | Intersection set |
| Intersections.id.id | Identification of intersection |
| Intersections.laneSet.list.array | Intersection lane set |
| Intersections.laneWidth | Intersection lane width |
| Intersections.laneSet.list.array[x]. | Identification of intersection |
| LaneID | lane x |
| Intersections.laneSet.list.array[x]. | Set of GPS coordinates of nodes |
| nodeList.choice.nodes.list.array | of lane x (wherein a lane is |
| | composed of multiple nodes to |
| | describe a curve section) |
| Intersection.refPoint.Long/Lat | GPS coordinates of reference |
| | points of intersection |
| Intersections.laneSet.list.array[x]. | Signal identification of |
| connection[y].signal_group | connection y related to lane x |

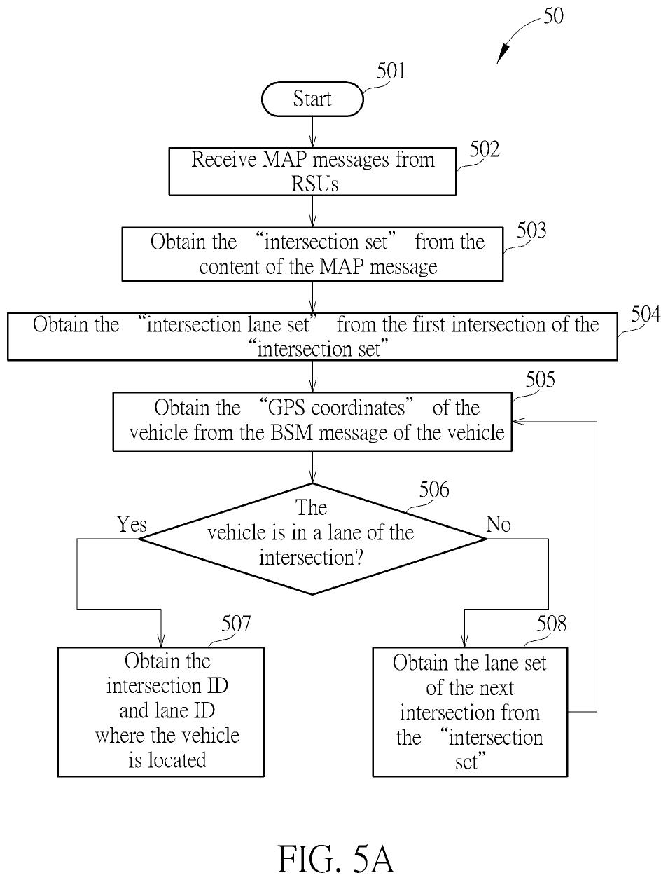

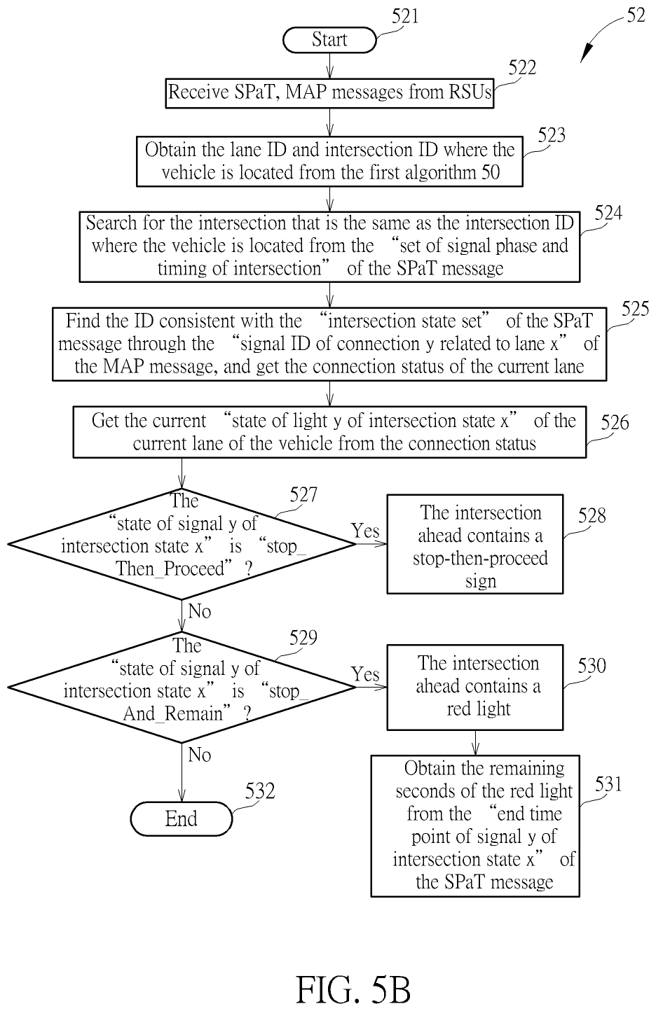

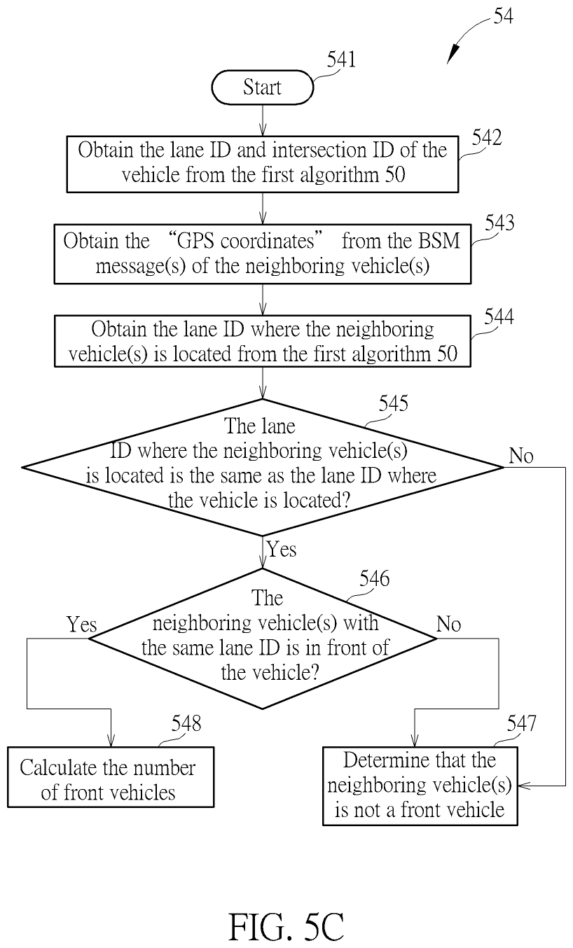

Through the BSM, SPAT, and MAP messages, the intelligent stop control system 14 may determine the driving lane, the ahead intersection information and the neighboring vehicle information of the vehicle. For example, in an embodiment, the intelligent stop control system 14 may execute a first algorithm 50, a second algorithm 52 and a third algorithm 54 based on the BSM, SPaT, and MAP messages. As shown in FIG. 5A, the first algorithm 50 includes the following steps:
Step 501: Start.
Step 502: Receive MAP messages from RSUs.
Step 503: Obtain the “intersection set” from the content of the MAP message (refer to Table 3).
Step 504: Obtain the “intersection lane set” from the first intersection of the “intersection set” (refer to Table 3).
Step 505: Obtain the “GPS coordinates” of the vehicle from the BSM message of the vehicle (refer to Table 1).
Step 506: Determine whether the vehicle is in a lane of the intersection based on the “intersection lane width”, the “GPS coordinates of nodes of the lane” in the lane set, and the “GPS coordinates” of the vehicle (refer to Tables 3 and 1). If yes, proceed to Step 507; if no, proceed to Step 508.
Step 507: Obtain the intersection ID and lane ID where the vehicle is located.
Step 508: Obtain the lane set of the next intersection from the “intersection set” and return to Step 505.

Therefore, through the first algorithm 50, the intelligent stop control system 14 may determine the driving lane of the vehicle (i.e., the lane ID where it is located) and the intersection ahead (i.e., the intersection ID).

In addition, as shown in FIG. 5B, the second algorithm 52 includes the following steps:
Step 521: Start.
Step 522: Receive SPaT, MAP messages from RSUs.
Step 523: Obtain the lane ID and intersection ID where the vehicle is located from the first algorithm 50.
Step 524: Search for the intersection that is the same as the intersection ID where the vehicle is located from the “set of signal phase and timing of intersection” of the SPAT message (refer to Table 2).
Step 525: Find the ID consistent with the “intersection state set” of the SPAT message (refer to Table 2) through the “signal ID of connection y related to lane x” of the MAP message (refer to Table 3), and get the connection status of the current lane.
Step 526: Get the current “state of light y of intersection state x” of the current lane of the vehicle from the connection status (refer to Table 2).
Step 527: Determine whether the “state of signal y of intersection state x” is “stop Then Proceed”; if yes, proceed to Step 528; if no, proceed to Step 529.
Step 528: Determine that the intersection ahead contains a stop-then-proceed sign.
Step 529: Determine whether the “state of signal y of intersection state x” is “stop And Remain”; if yes, proceed to Step 530; if no, proceed to Step 532.
Step 530: Determine that the intersection ahead contains a red light.
Step 531: Obtain the remaining seconds of the red light from the “end time point of signal y of intersection state x” of the SPaT message (refer to Table 2).
Step 532: End.

Therefore, through the second algorithm 52, the intelligent stop control system 14 may determine the signal, sign, and remaining seconds of the red light at the intersection ahead.

Furthermore, as shown in FIG. 5C, the third algorithm 54 includes the following steps:
Step 541: Start.
Step 542: Obtain the lane ID and intersection ID of the vehicle from the first algorithm 50.
Step 543: Obtain the “GPS coordinates” from the BSM message(s) of the neighboring vehicle(s) (refer to Table 1).
Step 544: Obtain the lane ID where the neighboring vehicle(s) is located from the first algorithm 50.
Step 545: Determine whether the lane ID where the neighboring vehicle(s) is located is the same as the lane ID where the vehicle is located; if the same, proceed to Step 546; if different, proceed to Step 547.
Step 546: Determine whether the neighboring vehicle(s) with the same lane ID is in front of the vehicle; if the same, proceed to Step 548; if different, proceed to Step 547.
Step 547: Determine that the neighboring vehicle(s) is not a front vehicle.
Step 548: Determine that the neighboring vehicle(s) is a front vehicle and calculate the number of front vehicles.

Therefore, through the third algorithm 54, the intelligent stop control system 14 may determine the information of neighboring vehicle(s), such as whether it is a front vehicle, the number of front vehicles, etc.

It should be noted that the first algorithm 50, the second algorithm 52, and the third algorithm 54 refer to using BSM, SPaT, and MAP messages to determine the driving lane of the vehicle, the information of the intersection ahead, and the information of neighboring vehicles, which are only feasible implementations of Step 402 in the process 40, but are not limited thereto. As mentioned in the above, different organizations have different definitions for V2V messages and V2I messages, so those skilled in the art should adopt appropriate algorithms or determining steps according to the application field to determine vehicle driving information and traffic environment information.

Returning to the process 40, after Step 402 determines the driving lane of the vehicle, the information of the intersection ahead, and the information of neighboring vehicles, Step 404 is executed to determine the expected halt period of stopping driving. At this time, different traffic or road conditions should be considered to ensure that the power system 16 maintains idling during a brief stop, and shuts down during a longer wait. For example, when the driver steps on the brake and stops the vehicle, the traffic conditions that the intelligent stop control system 14 needs to handle include but are not limited to the following:
1. When there is a traffic jam, if the front vehicles have all stopped, the power system 16 should be shut down; if the front vehicles are in a stop-and-go low-speed driving situation, e.g., the average speed of the front vehicles is greater than a preset speed, the power system 16 should maintain idling.
2. When encountering a red light, if the remaining seconds of the red light are greater than or equal to a third preset value, the power system 16 should be shut down; if the remaining seconds of the red light are less than the third preset value, but the number of front vehicles waiting for the red light is greater than a preset number, the power system 16 should be shut down; if the remaining seconds of the red light are less than the third preset value, but the number of front vehicles waiting for the red light is less than the preset number, the power system 16 should maintain idling.
3. When encountering a stop-then-proceed sign, because only a brief stop is needed to confirm the road conditions, there is no need to stop the power system 16; however, at this time, if there is a traffic jam ahead, the power system 16 should be shut down; on the contrary, if there are no front vehicles or the average speed of the front vehicle is greater than the preset speed, the power system 16 should maintain idling.
4. When the vehicle is turning or reversing, for example, turning or changing direction in alleys, correcting the direction of the vehicle when parking, or when there is an emergency situation that may hit the front vehicle and the driver steps on the brake, but there may be no road conditions ahead, the power system 16 should maintain idling at this time.

For the above traffic conditions, feasible implementations are sequentially explained with the first algorithm 50, the second algorithm 52, and the third algorithm 54 as examples. First, for the judgment of traffic jams, when the driver steps on the brake and stops the vehicle, if the intelligent stop control system 14 determines that there are neighboring vehicles (i.e., front vehicles) in front of the vehicle according to the third algorithm 54, the intelligent stop control system 14 may further determine the average speed of the front vehicles based on the BSM messages of the front vehicles. Accordingly, in response to the average speed of the front vehicles being less than a preset speed, for example, 10 kilometers/hour, it may be determined that there is a traffic jam in front of the vehicle, and the power system 16 may be shut down during severe traffic jams, or the power system 16 may maintain idling during mild traffic jams (stop-and-go low-speed driving). In another embodiment, if the vehicle is driving on a multi-lane road section, in addition to considering the average speed of the front vehicles, the average speed of the neighboring vehicles in the adjacent lane may also be considered. That is, when the intelligent stop control system 14 determines that there are neighboring vehicles in front of the driving lane of the vehicle and in the adjacent lane according to the third algorithm 54, the intelligent stop control system 14 may further determine the average speeds of the front vehicles and the neighboring vehicles in the adjacent lane based on the BSM messages of the front vehicles and the neighboring vehicles in the adjacent lane. Accordingly, in response to the average speeds of the front vehicles and the neighboring vehicles in the adjacent lane being both less than a preset speed, for example, 10 kilometers/hour, it can be determined that the road section where the vehicle is driving is congested, and the power system 16 may be shut down during severe traffic jams, or the power system 16 may maintain idling during mild traffic jams. It should be noted that only considering the average speed of the front vehicles and simultaneously considering the average speeds of different lanes are all applicable to the present invention, and those skilled in the art should appropriately adjust the criteria or means for judging traffic jams according to the needs of the system or application, and are not limited thereto.

Therefore, through the traffic status information of the V2X system 12, when the driver steps on the brake and stops the vehicle, the intelligent stop control system 14 can determine whether there is a traffic jam at the intersection ahead, and shut down the power system 16 during severe traffic jams (in response to the expected halt period being greater than or equal to the second preset value), and maintain the power system 16 idling when the front vehicles are in stop-and-go low-speed driving (in response to the expected halt period being less than the first preset value).

Furthermore, for the traffic situation of red lights, when the driver steps on the brake and stops the vehicle, the intelligent stop control system 14 may determine whether the intersection ahead includes a red light according to the second algorithm 52, and determine the remaining seconds when the red light is on. In this case, if the intersection ahead includes a red light, and the remaining seconds of the red light are greater than or equal to the third preset value (for example, 10 seconds), the intelligent stop control system 14 may determine that the expected halt period is longer (greater than or equal to the second preset value), and shut down the power system 16. On the other hand, if the remaining seconds of the red light are less than the third preset value, the number of front vehicles should also be considered because vehicles will lose time when they stop and start at signal transition, including deceleration delay and startup delay. Therefore, in one embodiment, if the deceleration delay of a single vehicle is 2 seconds, and the startup delay of the red light turning green is 3 seconds, then the intelligent stop control system 14 may multiply the number of front vehicles by 2 seconds, and add the startup loss time of 3 seconds and the remaining seconds of the red light. If the result is greater than the third preset value, it can be determined that the expected halt period is longer (greater than or equal to the second preset value), and the power system 16 is shut down; on the contrary, if the result is less than the third preset value, it can be determined that the expected halt period is shorter (less than the first preset value), it is a brief stop, and the power system 16 maintains idling. In other words, when the vehicle stops due to the red light turning on (starting), the intelligent control system 14 first determines whether the remaining time of the starting red light signal is greater than or equal to the third preset value. If so, the intelligent stop control system 14 may determine that the expected halt period is longer (greater than or equal to the second preset value), and shut down the power system 16. On the contrary, if the remaining time of the starting red light signal is less than the third preset value, the intelligent stop control system 14 further needs to consider whether the number of front vehicles is less than a preset number. The determination of the preset number is related to the remaining time of the red light signal, deceleration delay, and startup delay. Those skilled in the art may derive the preset number under different situations based on the above description, or summarize it into a corresponding table of the number of front vehicles and delay time, and accordingly determine the expected halt period.

In simple terms, when the driver stops the vehicle due to the red light turning on (starting), the intelligent stop control system 14 should determine the expected halt period based on the remaining seconds of the red light and the number of front vehicles, in order to shut down the power system 16 when the waiting time is longer, and maintain idling when it is a brief stop.

In addition, it should be noted that when the vehicle stops due to a red light, it may also encounter a traffic jam at the same time, and the intelligent stop control system 14 should shut down the power system 16 or maintain the power system 16 idling according to the aforementioned methods for traffic jams. That is to say, although the above description describes the traffic conditions of traffic jams and red lights separately, those skilled in the art should understand that actual traffic conditions may be mixed with different situations at the same time, and appropriate adjustments and modifications should be made.

Moreover, for the traffic situation of stop-then-proceed, similar to the aforementioned traffic situation of red lights, when the driver steps on the brake and stops the vehicle, the intelligent stop control system 14 may determine that the intersection ahead is a stop-then-proceed sign according to the second algorithm 52. Then, the intelligent stop control system 14 may determine whether there are front vehicles according to the third algorithm 54, and determine the average speed of the front vehicles based on the BSM messages of the front vehicles. If there are no vehicles ahead or the average speed of the front vehicles is greater than a preset speed, it means that only a brief stop is needed to start again; that is, the expected halt period is shorter (less than the first preset value), so the power system 16 maintains idling. On the contrary, if there is a traffic jam ahead, that is, the traffic situations of stop-then-proceed and traffic jam are mixed at the same time, the power system 16 should be shut down or the power system 16 should maintain idling according to the aforementioned methods for traffic jams.

Finally, for the traffic situation of vehicle turning, reversing, parking adjustment, or emergency stop, when the driver steps on the brake and stops the vehicle, if the intelligent stop control system 14 determines that the distance to the intersection ahead is greater than a preset distance according to the MAP message, or knows that the intersection ahead does not contain a starting red light signal or stop-then-proceed sign according to the second algorithm 52, and at the same time, determines that there are no front vehicles according to the third algorithm 54, or determines that the average speed of the neighboring vehicle(s) is greater than a preset speed based on the BSM message of the neighboring vehicle(s), it can be known that the driver stops the vehicle due to vehicle turning, reversing, parking adjustment, or emergency stop, so the intelligent stop control system 14 may determine that only a brief stop is needed, that is, the expected halt period is shorter (less than the first preset value), and the power system 16 maintains idling.

It should be noted that the aforementioned description of traffic conditions is only to indicate that the intelligent stop control system 14 can know and determine the reason for the stop driving based on the information of the V2X system 12, and then determine the expected halt period of the stop driving, so as to determine whether the vehicle will stay longer or just a brief stop due to actual traffic conditions, and correspondingly decide whether to maintain the power system 16 idling or shut down the power system 16. Therefore, those skilled in the art may appropriately adjust the operation mode of the intelligent stop control system 14 according to actual needs, and are not limited thereto. For example, some countries' traffic regulations stipulate that when a school bus stops to wait for students to get on and off, the vehicles in both directions of the road section where the school bus is located must stop until the school bus resumes driving. In this case, when those skilled in the art apply the intelligent stop control system 14 to this traffic situation, even if there are no vehicles ahead and no red lights or stop-then-proceed signs, the intelligent stop control system 14 can still determine the reason for the vehicle stop based on the information of the V2X system 12 is the school bus stop, and accordingly those skilled in the art should be able to adjust the operation mode of the intelligent stop control system 14, to determine whether to maintain the power system 16 idling or shut down the power system 16 based on the expected stop time of the school bus and the number of vehicles waiting ahead. Such adjustments and derivations of the operation mode of the intelligent stop control system 14 based on different countries or traffic regulations should be familiar to those skilled in the art.

Furthermore, those skilled in the art should understand that the traffic conditions that vehicles will encounter during driving may be complex and there are multiple traffic conditions, so the operation mode of the intelligent stop control system 14 needs to be appropriately adjusted according to different needs. In addition to presetting the operation logic of the intelligent stop control system 14, in one embodiment, different algorithms may also be induced and organized through artificial intelligence. In another embodiment, the transceiver module 206 can not only connect to the V2X system 12 to receive traffic status information, but also receive the update program of the operation logic, thereby adjusting the way the intelligent stop control system 14 controls the power system 16.

It should be noted that the process 40 is for the idling operation of gasoline vehicles. The intelligent stop control system 14 may use the traffic status information of the V2X system 12 to determine the expected halt period of the vehicle, and then decide whether to shut down the power system 16 or maintain idling. In addition, for the kinetic energy recovery of electric vehicles or hybrid vehicles, those skilled in the art should be able to appropriately change and derive based on the aforementioned idling control of gasoline vehicles; for example, the intelligent stop control system 14 may determine the road conditions in the direction of the vehicle based on the traffic status information of the V2X system 12, thereby adjusting the operation of kinetic energy recovery.

For example, for electric vehicles or hybrid vehicles, when the driver steps on the brake, if the intelligent stop control system 14 determines that there are neighboring vehicles in front of the vehicle (i.e., front vehicles) according to the third algorithm 54, the intelligent stop control system 14 may further determine the average speed of the front vehicles based on the BSM messages of the front vehicles. Accordingly, in response to the average speed of the front vehicles and/or neighboring vehicles being less than a first preset speed but greater than a second preset speed, it can be determined that the traffic flow ahead is crawling at low speed but not severe enough to completely stop or stop and go, then the intelligent stop control system 14 may turn off the kinetic energy recovery of the power system 16 or reduce the recovery intensity to reduce the sense of jerkiness. In another embodiment, in response to the average speed of the front vehicles and/or neighboring vehicles being greater than a preset speed, it can be determined that the traffic flow of the road section is smooth, or the intelligent stop control system 14 determines that the vehicle is driving on a long downhill according to the first algorithm 50, then the intelligent stop control system 14 may turn on the kinetic energy recovery of the power system 16 or increase the recovery intensity to reduce the wear of the brake system and extend the cruising range. In the prior art, the idle stop system of a gasoline vehicle adopts a fixed detection and activation mechanism, which may cause frequent interventions and cause annoying delays and jerks, and may also cause unnecessary wear of the power system, reduce the performance of air conditioning and generators, etc.; and the kinetic energy recovery system of electric vehicles or hybrid vehicles is manually turned on and off and set to a fixed recovery intensity, which may cause obvious jerkiness or cannot effectively extend the cruising range. In contrast, for gasoline vehicles, the embodiments of the present invention can know and determine the reason for the vehicle's stop driving based on the information of the vehicle network system, and then determine the expected halt period of the vehicle's stop driving, and then determine whether the vehicle will stay longer or just a brief stop due to actual traffic conditions, and correspondingly decide whether to maintain the power system idling or shut down the power system; or, for electric vehicles or hybrid vehicles, the embodiments of the present invention can know and determine the traffic conditions based on the information of the vehicle network system, and then decide whether to start kinetic energy recovery or adjust the intensity of kinetic energy recovery. Therefore, the embodiments of the present invention can appropriately adjust the operation mode of idle stop or kinetic energy recovery according to actual needs, not only can reduce the discomfort of drivers or passengers, but also can maintain the effect of energy saving and carbon reduction.

In summary, the present invention can appropriately adjust the operation mode of idle stop and kinetic energy recovery according to actual needs, thereby improving the user experience and achieving the effect of energy saving and carbon reduction.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An intelligent stop control method, for a vehicle, the intelligent stop control method comprising:
obtaining a traffic status information related to the vehicle through a vehicle-to-everything system when the vehicle is driving; and
in response to activation of a brake system of the vehicle, controlling operation of a power system of the vehicle based on the traffic status information.

2. The intelligent stop control method of claim 1, wherein the step of controlling the operation of the power system of the vehicle based on the traffic status information comprises:
determining a driving lane of the vehicle and intersection information and neighboring vehicle information related to a driving direction of the vehicle based on the traffic status information;
determining an expected stop time of the vehicle stopping driving based on the driving lane, the intersection information, and the neighboring vehicle information;
in response to the expected stop time being less than a first threshold, maintaining an idling operation of the power system of the vehicle; and
in response to the expected stop time being greater than or equal to a second threshold, stopping the operation of the power system of the vehicle.

3. The intelligent stop control method of claim 2, wherein the step of determining the expected stop time of the vehicle based on the driving lane, the intersection information, and the neighboring vehicle information comprises:
In response to the neighboring vehicle information indicating that an average speed of vehicles in front of the vehicle in the driving lane is less than a preset speed, determining that the expected stop time is greater than or equal to the second threshold.

4. The intelligent stop control method of claim 2, wherein the step of determining the expected stop time of the vehicle based on the driving lane, the intersection information, and the neighboring vehicle information comprises:
in response to the intersection information indicating that an intersection in front of the driving lane comprises an activated red light signal, and a remaining time of the activated red light signal is less than a third threshold, and the neighboring vehicle information indicating that a number of vehicles in front of the vehicle to the intersection is less than a preset number, determining that the expected stop time is less than the first threshold.

5. The intelligent stop control method of claim 2, wherein the step of determining the expected stop time of the vehicle based on the driving lane, the intersection information, and the neighboring vehicle information comprises:
in response to the intersection information indicating that an intersection in front of the driving lane comprises an activated red light signal, and a remaining time of the activated red light signal is less than a third threshold, and the neighboring vehicle information indicating that a number of vehicles in front of the vehicle to the intersection is greater than a preset number, determining that the expected stop time is greater than or equal to the second threshold.

6. The intelligent stop control method of claim 2, wherein the step of determining the expected stop time of the vehicle based on the driving lane, the intersection information, and the neighboring vehicle information comprises:
in response to the intersection information indicating that an intersection in front of the driving lane comprises an activated red light signal, and a remaining time of the activated red light signal is greater than or equal to a third threshold, determining that the expected stop time is greater than or equal to the second threshold.

7. The intelligent stop control method of claim 2, wherein the step of determining the expected stop time of the vehicle based on the driving lane, the intersection information, and the neighboring vehicle information comprises:
in response to the intersection information indicating that an intersection in front of the driving lane comprises a stop and go sign, and the neighboring vehicle information indicating that the vehicle has no front vehicle or an average speed of vehicles in front of the vehicle is greater than a preset speed, determining that the expected stop time is less than the first threshold.

8. The intelligent stop control method of claim 2, wherein the step of determining the expected stop time of the vehicle based on the driving lane, the intersection information, and the neighboring vehicle information comprises:
in response to the intersection information indicating that a distance from the vehicle to an intersection in front of the driving lane is greater than a preset distance or the intersection does not contain an activated red light signal or a stop and go sign, and the neighboring vehicle information indicating that the vehicle has no front vehicle or an average speed of neighboring vehicles of the vehicle is greater than a preset speed, determining that the expected stop time is less than the first threshold.

9. The intelligent stop control method of claim 2, wherein the first threshold is equal to the second threshold.

10. The intelligent stop control method of claim 1, wherein the traffic status information of comprises a plurality Vehicle-to-Vehicle messages and a plurality of Vehicle-to-Infrastructure messages.

11. An intelligent stop control system for a vehicle, the intelligent stop control system comprising:
a processing unit;
a transceiver module, coupled to the processing unit, configured to connect a vehicle-to-everything system;
a storage unit, coupled to the processing unit, storing a program code, wherein the program code is used to instruct the processing unit to execute an intelligent stop control method, wherein the intelligent stop control method comprises the following steps:
obtaining a traffic status information related to the vehicle through the vehicle-to-everything system when the vehicle is driving; and
in response to activation of a brake system of the vehicle, controlling operation of a power system of the vehicle based on the traffic status information.

12. The intelligent stop control system of claim 11, wherein the step of controlling the operation of the power system of the vehicle based on the traffic status information comprises:
determining a driving lane of the vehicle and intersection information and neighboring vehicle information related to a driving direction of the vehicle based on the traffic status information;
determining an expected stop time of the vehicle stopping driving based on the driving lane, the intersection information, and the neighboring vehicle information;
in response to the expected stop time being less than a first threshold, maintaining an idling operation of the power system of the vehicle; and
in response to the expected stop time being greater than or equal to a second threshold, stopping the operation of the power system of the vehicle.

13. The intelligent stop control system of claim 12, wherein the step of determining the expected stop time of the vehicle based on the driving lane, the intersection information, and the neighboring vehicle information comprises:
in response to the neighboring vehicle information indicating that an average speed of vehicles in front of the vehicle in the driving lane is less than a preset speed, determining that the expected stop time is greater than or equal to the second threshold.

14. The intelligent stop control system of claim 12, wherein the step of determining the expected stop time of the vehicle based on the driving lane, the intersection information, and the neighboring vehicle information comprises:
in response to the intersection information indicating that an intersection in front of the driving lane comprises an activated red light signal, and a remaining time of the activated red light signal is less than a third threshold, and the neighboring vehicle information indicating that a number of vehicles in front of the vehicle to the intersection is less than a preset number, determining that the expected stop time is less than the first threshold.

15. The intelligent stop control system of claim 12, wherein the step of determining the expected stop time of the vehicle based on the driving lane, the intersection information, and the neighboring vehicle information comprises:
in response to the intersection information indicating that an intersection in front of the driving lane comprises an activated red light signal, and a remaining time of the activated red light signal is less than a third threshold, and the neighboring vehicle information indicating that a number of vehicles in front of the vehicle to the intersection is greater than a preset number, determining that the expected stop time is greater than or equal to the second threshold.

16. The intelligent stop control system of claim 12, wherein the step of determining the expected stop time of the vehicle based on the driving lane, the intersection information, and the neighboring vehicle information comprises:
in response to the intersection information indicating that an intersection in front of the driving lane comprises an activated red light signal, and a remaining time of the activated red light signal is greater than or equal to a third threshold, determining that the expected stop time is greater than or equal to the second threshold.

17. The intelligent stop control system of claim 12, wherein the step of determining the expected stop time of the vehicle based on the driving lane, the intersection information, and the neighboring vehicle information comprises:
in response to the intersection information indicating that an intersection in front of the driving lane comprises a stop and go sign, and the neighboring vehicle information indicating that the vehicle has no front vehicle or an average speed of vehicles in front of the vehicle is greater than a preset speed, determining that the expected stop time is less than the first threshold.

18. The intelligent stop control system of claim 12, wherein the step of determining the expected stop time of the vehicle based on the driving lane, the intersection information, and the neighboring vehicle information comprises:
in response to the intersection information indicating that a distance from the vehicle to an intersection in front of the driving lane is greater than a preset distance or the intersection does not contain an activated red light signal or a stop and go sign, and the neighboring vehicle information indicating that the vehicle has no front vehicle or an average speed of neighboring vehicles of the vehicle is greater than a preset speed, determining that the expected stop time is less than the first threshold.

19. The intelligent stop control system of claim 12, wherein the first threshold is equal to the second threshold.

20. The intelligent stop control system of claim 11, wherein the traffic status information comprises a plurality of Vehicle-to-Vehicle messages and a plurality of Vehicle-to-Infrastructure messages.
